(19) United States
(12) Patent Application Publication
(10) Pub. No.: US 2002/0042713 A1
(43) Pub. Date: Apr. 11, 2002

(54) Toy having speech recognition function and two-way conversation for dialogue partner

(75) Inventors: Sang Seol Kim, Seoul (KR); Joon Hyung Ryoo, Kyunggido (KR); Won Il Kang, Kyunggido (KR); Young Jong Park, Kyunggido (KR); Eun Ja Kim, Seoul (KR); Suk Bong Kwon, Seoul (KR); Jae Kyung Lee, Kwangju City (KR); Kyoung Jae Ji, Kyungsangnamdo (KR); Tae Sik Bang, Kyunggido (KR); Joo Young Han, Koyang City (KR)

Correspondence Address: McDERMOTT, WILL & EMERY, 600 13th Street, N.W., Washington, DC, 20005-3096, US

(73) Assignee: KOREA AXIS CO., LTD.

(21) Appl. No.: 09/934,475

(22) Filed: Aug. 23, 2001

Related U.S. Application Data
(63) Continuation-in-part of application No. 09/321,626, filed on May 28, 1999.

(30) Foreign Application Priority Data
May 10, 1999 (KR) 99-16583

(51) Int. Cl. G10L 21/00

(52) U.S. Cl. 704/272

(57) ABSTRACT

A toy having a speech recognition function for two-way conversation with a dialogue partner. Digital speech processing circuitry incorporates first and second measures together with speech recognition components, to store speech compression data and recognition data, for controlling sentence generation in response to speech recovered from the partner.

### BACKGROUND OF THE INVENTION

1. Field of the Invention

The present invention relates to a toy having a speech recognition function and two-way conversation f or a dialogue partner, and more particularly, to a toy having a speech recognition function and two-way conversation for a dialogue partner in which a speech recognition system is installed in the interior thereof to thereby have an interesting conversation (audible speech) with the dialogue partner(a user).

2. Discussion of Related Art

Generally, growing children tend to learn practical education through exciting plays or with toys, and are likely to have intimate relationship with the toys to experience an imitative learning for their real life. Specifically, various kinds of dolls are used for the imitative learning and the children with the dolls extract adequate responses from the dolls in accordance with the scenario of the imitative learning. In more detail, they have a talk with the dolls and create the operation of them in response to the conversation content in two-way conversation manner, which results in the absorption in the imitative learning.

As known, the children's education pattern through all kinds of plays with toys has been continued from old times. Recently, there are presented talking toys providing an excellent educational effect for children, and by way of example, tries for the development of more advanced talking dolls are continuously made.

Most of conventional toys have a touch sensor (switch) in a specific portion thereof and if the touch sensor operates by the manipulation of a user (a dialogue partner), simple, discontinuous speech expression, e.g. “Hi, I am chul-soo, Who are you?”, “What are you doing?” and so on, which has been previously stored in a magnetic recording medium(tape) or a semiconductor recording medium (IC memory), is audibly delivered to the dialogue partner. Additionally, the conventional toys have simple and fixed motions such as, for example, a lifting motion of the arm, a moving motion of the head and the like, which stimulates only a temporary curiosity from the dialogue partner.

Therefore, the conventional toys have only some discontinuous, simple speech expression and since they deliver recorded speech where a predetermined scenario is not contained to the dialogue partner in accordance with the operation of the touch sensor, they arouse a temporary curiosity from the dialogue partner. More particularly, the dialogue partner is likely to lose an interest in playing the toy, so that real use time of the toy can be shortened, which results in reduction of the effective value of the toy.

Moreover, since the speech expression delivered from the conventional toys is not a scenario based upon two-way conversation, but simple and discontinuous words, the toys have not possess any realistic sensing capability, which of course reduce the effective value thereof to finally shorten the toy's use time.

### SUMMARY OF THE INVENTION

Accordingly, the present invention is directed to a toy having a speech recognition function and two-way conversation for a dialogue partner that substantially obviates one or more of the problems due to limitations and disadvantages of the related arts.

An object of the invention is to provide a toy having a speech recognition function and two-way conversation for a dialogue partner which is capable of recognizing a dialogue partner's speech and conversing with the dialogue partner in the continuous manner in accordance with at least one or more scenarios selected by the dialogue partner's thought and behavior patterns.

Another object of the invention is to provide a toy having a speech recognition function and two-way conversation for a dialogue partner which can execute a speech output which is adequate for a situation where the subject of conversation is based, and in this case, since a predetermined scenario where a dialogue partner's possible behavior pattern is recorded is stored, can have two-way conversation with the dialogue partner in accordance with the selection of the scenario corresponding to an arbitrary set situation.

Still another object of the invention is to provide a toy having a speech recognition function and two-way conversation for a dialogue partner which can have a speech output system in which the speech is compressed by means of a speech compressing software to draw various kinds of scenarios at the state where the conversation with the dialogue partner is continued, the compressed speech is stored in a ROM and the stored information is decoded if necessary, and can execute immediate inquiry and response in the selective situation even with single subject of conversation.

Yet another object of the invention is to provide a toy having a speech recognition function and two-way conversation for a dialogue partner which can learn the speech of a plurality of unspecified persons in a speaker independent type of speech recognition pattern to understand the speech of the plurality of unspecified persons, thus to achieve a reasonable reaction result.

Another object of the invention is to provide a toy having a speech recognition function and two-way conversation for a dialogue partner which can discriminate the speech of the dialogue partner from the noises on the surrounding, that is, the noises generated when the dialogue partner touches or rubs the toy, to thereby filter the noises from the dialogue partner's speech.

Still another object of the invention is to provide a toy having a speech recognition function and two-way conversation for a dialogue partner which can perform a proper speech reaction to attract the dialogue partner's interest by installing four touch switches, when the toy's posture is changed and the dialogue partner touches a predetermined portion of the toy, i.e. the dialogue partner is in contact with the toy.

Yet another object of the invention is to provide a toy having a speech recognition function and two-way conversation for a dialogue partner which can construct a hardware having a system which recognizes an inputted speech signal and interprets the recognized signal in an appropriate manner to exhibit a realistic reaction with a real time response and can output a practical content (a scenario) from a previously stored database, as if the response is made by a person. Yet still another object of the invention is to provide a toy having a speech recognition function and two-way conversation for a dialogue partner which can include a speech decoder, a speech recognizer, a system controller, a dialogue manager, and other components having various kinds of auxiliary functions, whereby advanced software and circuit manufacturing technology is realized to meet various kinds of functions and performance, and can have a speaker-independent, artificial intelligence, and two-way conversation performance to thereby increase a language education effect (language education, play education and the like).

According to an aspect of the present invention, there is provided a toy having a speech recognition function and two-way conversation for a dialogue partner, which has a first memory for storing speech compression data made by compressing a plurality of digital speech signal streams in a toy body that has a predetermined receiving space and is of at least one of human body and animal shapes and a second memory in which an operation space is arranged for recognizing a dialogue partner's speech signal inputted from the outside, the toy including: a speech input/output part for converting at least one sentence of the dialogue partner's speech signal stored in the second memory into an electrical speech signal to output the converted signal and for audibly transmitting the speech signal restored to the dialogue partner; a circular buffer in which the dialogue partner's digital speech signal outputted from the speech input/output part is temporarily stored; a speech recognizer for dividing the digital speech signal stored in the circular buffer into speech recognizing words in accordance with speech recognizing constant of the compression data stored in the first memory to thereby recognize the dialogue partner's speech by Viterbi algorithm; a dialogue manager for selecting at least one response sentence from the first memory to match the content of the speech recognized in the speech recognizer with a predetermined scenario; a speech decoder for extending and restoring the speech compression data of the first memory selected from the dialogue manager; an analog/digital and digital/analog(hereinafter, referred to as A/D and D/A) converter arranged between the speech decoder and the speech input/output part, for converting one side of analog and digital speech signals into the other side thereof; and a memory controller arranged between the second memory and the speech recognizer, for moving the data from the first memory to the second memory.

Preferably, a list controller is arranged between the speech recognizer and the first memory and between the dialogue manager and the first memory, for extracting the speech compression data and the speech recognizing constant from the first memory and for moving the speech recognizing data to the second memory.

The speech recognizer is preferably comprised of: a speech recognizing calculator which eliminates a predetermined noise from the digital speech signal in a frame unit stored in the circular buffer in accordance with the speech recognizing constant of the first memory to thereby calculate an inherent value for a single character as feature vector data; zerocrossing rate for detecting a zero point in a sampling value of the digital speech signal; power energy which calculates energy for the zero point to improve the reliability for the zero point detection at the zerocrossing rate; a unit speech detector which detects endpoint data of any one word of the continuous digital speech signals, based upon the output signals of the zerocrossing rate and the power energy; a preprocessor which divides the feature vector data of the speech recognizing calculator and the endpoint data of the unit speech detector by one word into the speech recognizing word; and the second memory which provides an operation area where the speech compression data of the first memory corresponding to the divided word in the preprocessor which has been extracted by means of the list controller is operated by the Viterbi algorithm.

On the other hand, the toy having a speech recognition function and two-way conversation for the dialogue partner (a user) according to the present invention further includes: a plurality of touch switches which are mounted on plural areas, for example, the back, nose, mouth, and hip, of the toy body and serve to inform the speech decoder of the dialogue partner's contact with the toy body.

In this case, if the dialogue partner contacts the touch switches, the speech corresponding to the touched situation is extracted from the dialogue manager and the first memory. Next, the extracted speech compression data is extended and restored into a real speech in the speech decoder, and the real speech is audibly sent to the dialogue partner via the speaker of the speech input/output part.

The speech input/output part preferably includes a first microphone for converting the dialogue partner's speech and the noise generated from the outside into an electrical signal to thereby output the converted signal to the circular buffer, a second microphone for converting the noise generated from the outside into an electrical signal to thereby output the converted signal to the circular buffer, and a power amplifier for amplifying the extended and restored speech signal from the speech decoder to audibly deliver the amplified signal via a speaker to the dialogue partner.

Preferably, the analog/digital and digital/analog converter is arranged between the circular buffer and the first and second microphones, for converting the output signals from the first and second microphones into digital signals, and also arranged between the speech decoder and the power amplifier, for converting the extended and restored digital speech signal from the speech decoder into an analog signal.

Also, it is preferable that a volume controller is disposed between the A/D and D/A converter and the power amplifier, for adjusting an output strength of the power amplifier in response to the dialogue partner's volume adjustment command (for example, “speak louder” and “speak softer”).

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the drawings.

In the drawings:

FIG. 1 is a front view illustrating a toy having a speech recognition function and two-way conversation for a dialogue partner according to the present invention;

FIG. 2 is a side view in FIG. 1;

FIG. 3 is a block diagram illustrating a system configuration of a toy having a speech recognition function and two-way conversation for a dialogue partner according to the present invention;

FIG. 4 is a flow chart illustrating the process order of FIG. 3; and

FIG. 5 is a detailed block diagram illustrating the ASIC-ed speech recognizer in the system configuration of the toy according to the present invention.

### DETAILED DESCRIPTION OF PREFERRED EMBODIMENT

Reference will now be made in detail to the preferred embodiments of the present invention, examples of which are illustrated in the accompanying drawings.

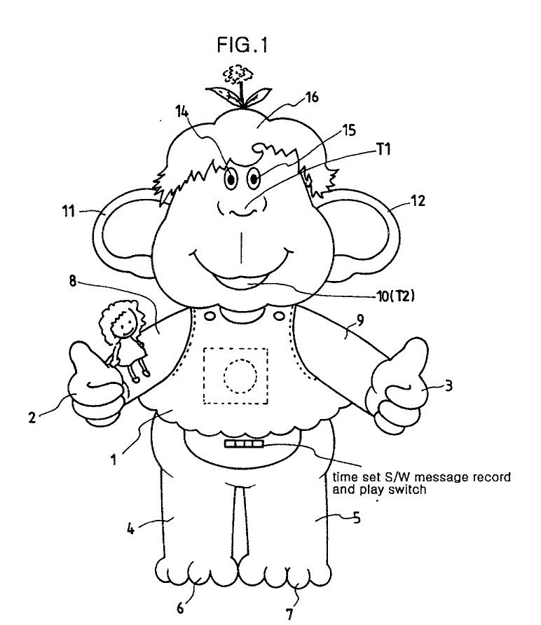

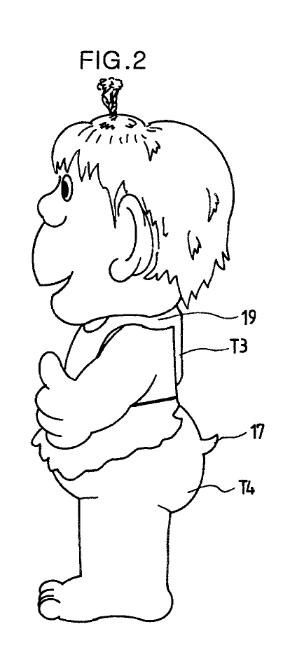

As shown in FIGS. 1 and 2, a toy of the present invention is a kind of a stuffed toy and is surrounded with an outer skin. And, it has the face and body interiors in which rigid frame (not shown) is constructed to protect the circuit mounted therein.

In more detail, the toy takes a fairy appearance similar to the human being. The upper part of the toy body is comprised of abdomen and back 1, two hands 2 and 3 each having four fingers, and two arms 8 and 9, and the lower part thereof is comprised of two legs 4 and 5, two feet 6 and 7 each having four toes, and hip and tail 17. The face of the toy is filled with a mouth 10, two ears 11 and 12, hair 16, and two eyes 14 and 15. Referring to FIG. 2 showing a side view of FIG. 1, a neck 19, which connects the face and the body of the toy, is made of a flexible material to thereby facilitate the easy connection of the circuit installed in the head of the toy with the electrical wire in the body of the toy. Moreover, the toy has very beautiful appearance and is surrounded with a smooth skin for protecting the interior circuit.

A touch switch, which induces the reaction of the toy upon contact with the dialogue partner, is installed on the nose T1, mouth T2, back T3, and hip T4 of the toy body, respectively. The touch switches T1 to T4 are custom-made to exhibit a good sensing performance. Thus, the touch switch has a high sensitivity and when installed in the interior of the outer skin of the toy and contacted with the dialogue partner, a high active signal is directly inputted to the controller (ASIC: custom semiconductor-microprocessor) of the touch switch to induce the speech reaction therefrom. The touch switch T4 serves to sense whether the toy stands up or sits down to induce a proper speech reaction to the sensed result.

For instance, if the toy lies down, the speech reaction induced from the touch switch T4 is a speech indication “Umm, do you want me to go to sleep.”, and if it stands up, a speech indication “I'm up, wanna play.”. On the other hand, if the dialogue partner touches the mouth, the speech reaction induced from the touch switch T2 is a speech indication “Yum!, Yum!, Umm!, good and delicious.”, and if he moves the hand from the mouth, a speech indication “I'm hungry.”. If the dialogue partner touches the back, the speech reaction induced from the touch switch T3 is a speech indication “Kuck, who was that.”, and if he touches the nose, the speech reaction induced from the touch switch T1 is a speech indication “Tickles, haah . . . ”.

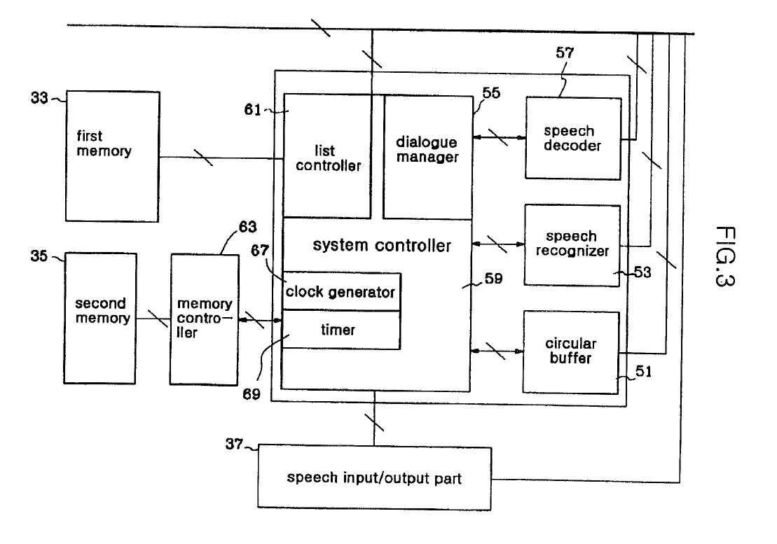

As shown in FIG. 3, the system of the toy according to the present invention is comprised of a circular buffer 51, a speech recognizer 53, a speech decoder 57, an A/D D/A converter 47, a memory controller 63, a first memory (ROM) 33, a second memory (RAM) 35 and a speech input/output part 37. The first memory 33 stores speech compression data made by compressing a plurality of sentences of digital speech signal streams in a predetermined compression ratio. The second memory 35 arranges storage space for recognizing a dialogue partner's speech signal inputted from the outside. The speech recognizer 53 recognizes the dialogue partner's speech signal by using the storage space of the second memory 35 and analyzes conversation type response to the recognized content to extend and restore speech compression data from the first memory 33 that corresponds with the analyzed response. The speech input/output part 37 converts at least one sentence of the dialogue partner's speech signal into an electrical speech signal to output the converted signal to the circular buffer 51] and audibly transmits the speech signal extended from the speech decoder 57 to the dialogue partner.

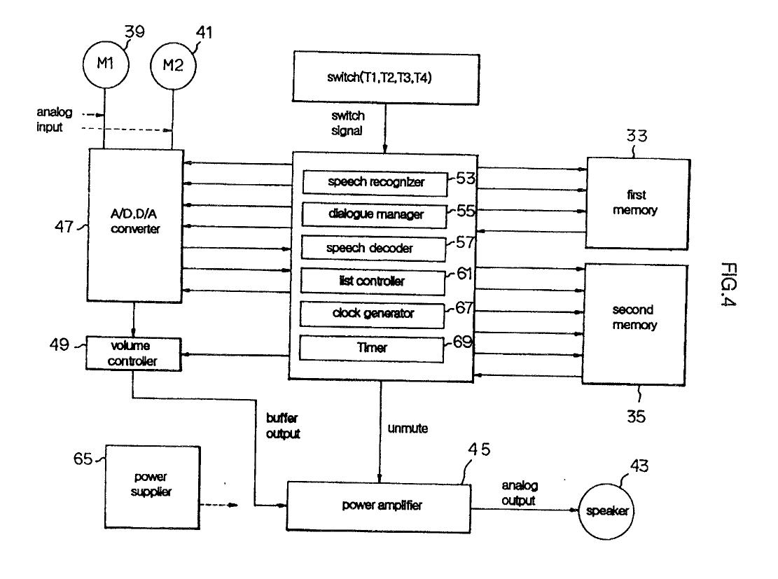

As shown in FIG. 4, the speech input/output part 37 includes a first microphone 39 for converting the dialogue partner's speech and the noise generated from the outer skin of the toy into an electrical signal to thereby output the converted signal to the circular buffer 51, a second microphone 41 for converting the noise generated from the outside into an electrical signal to thereby output the converted signal to the circular buffer 51, and a power amplifier 45 for amplifying the extended and restored speech signal from the speech recognizer 53 to audibly deliver the amplified signal via a speaker 43 to the dialogue partner. An A/D and D/A converter 47 is arranged between the circular buffer 51 and the first and second microphones 39 and 41, for converting the output signals from the first and second microphones 39 and 41 into digital signals, and is also arranged between the speech decoder 57 and the power amplifier 45, for converting the extended and restored digital speech signal from the speech decoder 57 into an analog signal. In this case, the speaker 43 serves to audibly deliver the compressed speech stored in the first memory 33 which is signal processed under a predetermined order to the dialogue partner.

Meanwhile, a volume controller 49 is disposed between the A/D and D/A converter 47 and the power amplifier 45, for adjusting an output strength of the power amplifier 45 to control the speech volume generated from the speaker 43. By way of example, to adjust the dialogue partner's desired volume strength, if a dialogue partner's volume adjustment command (for example, “speak louder” and “speak softer”) is inputted from the first microphone 39 via the A/D and D/A converter 47, the volume controller 49 controls the power amplifier 45 in such a manner that the speaker 43 generates the speech volume corresponding to the dialogue partner's volume adjustment command. As a result, the power amplifier 45 has the size, i.e. gain which is dependent upon an unmute signal of a system controller 59 and an output signal of the volume controller 49.

The first and second microphones 39 and 41 of the speech input/output part 37 have a noise removing function. For example, a signal, which is generated by mixing speech and noises, is inputted to the first microphones 39, and a pure noise signal, which is generated when the toy is contacted with the dialogue partner or is affected by the surrounding noises, is inputted to the second microphone 41. At this time, correlation between the noises of the two signals in the first and second microphones 39 and 41 is carried out, thereby removing only the noise components. In other words, the speech and noise signal inputted through the first microphone 39 is correlated with the pure noise signal inputted from the second microphone 41 to thereby remove only the noise component therefrom. The first and second microphones 39 and 41 are mounted on the both ears of the toy, based upon an experimental ground, and any of them is a small-sized stereo microphone, which is sensitive to a speech frequency band and has a strong directivity.

Referring to FIG. 4, as mentioned above, the touch switches T1 to T4 are directly connected to the speech decoder 57.

The circular buffer 51 in which the dialogue partner's digital speech signal outputted from the speech input/output part 37, that is, a speech sampling signal digitalized in a frame unit converted in the A/D and D/A converter 47 is temporarily stored. The speech recognizer 53 divides the digital speech signal stored in the circular buffer 51 into speech recognizing words in accordance with speech recognizing constant of the compression data stored in the first memory 33 to thereby recognize the dialogue partner's speech by Viterbi algorithm. The dialogue manager 55 selects at least one scenario among a plurality of scenarios where the content of the speech recognized in the speech recognizer 53 is developed and extracts at least one sentence of the speech compression data to correspond with the selected scenario from the first memory 33. The speech decoder 57 extends and restores the speech compression data extracted from the dialogue manager 55 to output the processed data to the speech input/output part 37. The system controller 59 is disposed for outputting a control signal to the first memory 33, the second memory 35, the volume controller 49, the A/D and D/A converter 47 and the power amplifier 45, respectively.

Furthermore, if the dialogue partner touches the touch switch installed on the mouth, nose, back and hip of the toy body, respectively, the speech compression data corresponding to the touched situation is extracted from the dialogue manager 55 and the first memory 33. Next, the extracted speech compression data is extended and restored into a real speech in the speech decoder 57, and the real speech is audibly sent to the dialogue partner via the speaker 43 of the speech input/output part 37.

According to the present invention, the circular buffer, the speech recognizer, the dialogue manager, the speech decoder, the timer, the clock generator and the list controller are all ASIC-ed within a single chip.

The first memory 33 records speech having numerous sentences, music, a plurality of conversation data, speech recognizing constant and restoring data for speech decoding therein as a compressed data. The first memory 33 has a large storage capacity of 4 MBits or more and stores the data in one word (16 bits) unit. This can store total 2 Mwords data. The stored information content in the first memory 33 is given by the following table <1>.

TABLE 1

| | | stored | |
|---|---|---|---|
| storage | | amount (1 word = | |
| content | Type | 16 bit) | others |
| compressed | speech information (160 | 1,888 kwords | about |
| sound | sentences) | | 75 |
| | music (5) | | minutes |
| | cradle song (2) | | |
| | conversation (5) | | |
| speech | function calculating | 32 kwords | 15 |
| decoding data | constant | | |
| speech | function calculating | 92 kwords | 9 |
| recognizing | constant | | |
| data | | | |

The second memory 35 stores a process program for processing the dialogue partner's speech and the speech of the response sentence, and includes a block list structure space as an element for an internal data signal process and a use space for the preprocessing of the speech recognition. And, it has [a predetermined data] storage capacity. At this time, the list controller 60 serves to extract the data of the second memory 35 and the compression speech data of the first memory 33 to thereby output the extracted data to the speech decoder 57.

In this case, a memory controller 63 is arranged between the second memory 35 and the speech recognizer 53], for moving the data from the first memory 33 to the second memory 35.

On the other hand, a power regulator 65 maintains an arbitrary voltage in the voltage variation range of 3 to 24V at a constant voltage of 3.3V and basically, uses a voltage (4.5V) of three batteries that are connected in serial to each other, which may of course be varied. As other requisite components, there are arranged a clock generator 67 of 24.546 MHz for generating the clock of the second memory 35 and a timer 69 of 32.768 kHz, and an explanation of them will be excluded in this detailed description for the sake of brevity.

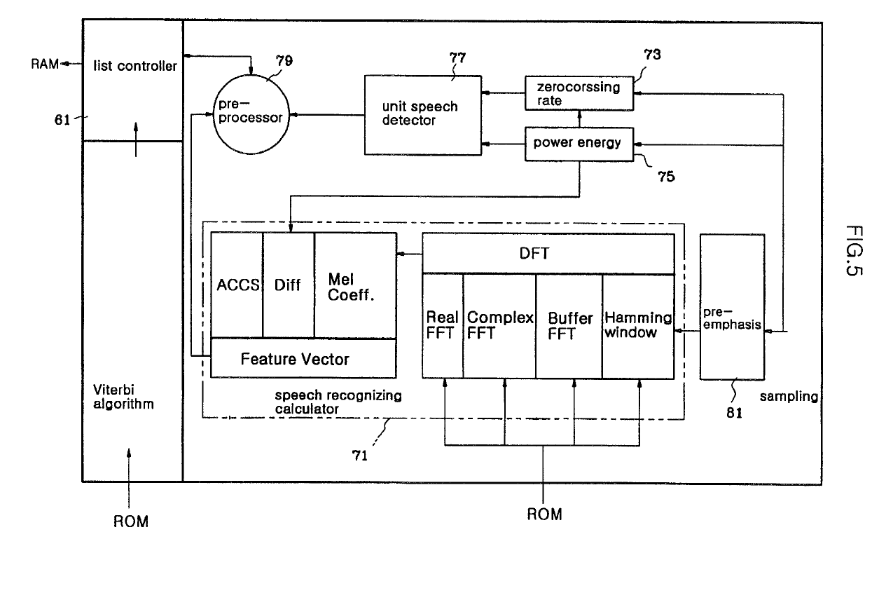

The speech recognizer 53, as shown in FIG. 5, is comprised of: a speech recognizing calculator 71 which eliminates a predetermined noise from the digital speech signal in a frame unit stored in the circular buffer 51 in accordance with the speech recognizing constant of the first memory 33 to thereby calculate an inherent value for a single character as feature vector data; a zerocrossing rate 73 for detecting a zero point in a sampling value of the digital speech signal; a power energy 75 which calculates energy for the zero point to improve the reliability for the zero point detection at the zerocrossing rate 73; a unit speech detector 77 which detects endpoint data of any one word of the continuous digital speech signals, based upon the output signal of the zerocrossing rate 75 and the power energy 75; a preprocessor 79 which divides the feature vector data of the speech recognizing calculator 71 and the endpoint data of the unit speech detector 77 by one word into the speech recognizing word; and the second memory 35 which provides an operation area where the speech compression data of the first memory 33 corresponding to the divided word in the preprocessor 79 which has been extracted by means of the list controller 61 is operated by the Viterbi algorithm. In this case, a preemphasis 81 is arranged between the speech recognizing calculator 71 and the circular buffer 51, for frequency-amplifying the digital speech signal of the circular buffer 51 for the rapid signal processing.

In more detail, the calculation flow and the module of the speech recognizer 53 is structured with two module groups, each which has a plurality of sub-modules where the Viterbi algorithm and speech detector algorithm are directed to the custom semiconductor.

First, the Viterbi algorithm is comprised of one chip set using a Hidden Markov Model(HMM) which can be used in the toys for the dialogue partners of 4 to 10 years old. Furthermore, the block list structure arranged in the second memory 35 (16 Mbits) is built to process numerous variable data occurring during the Viterbi algorithm execution, which is operated in about 1 Mbits area of the second memory 35. The HMM learning method ensures that the reliability can be improved even though the user is changed, that is, ensures a speaker independent type recognition and speech recognition in a phoneme unit.

An explanation of the operation of each component in FIGS. 3 to 5, as mentioned above, will be discussed hereinafter.

Firstly, the first and second microphones 39 and 41 receive the speech signals and convert them into the electrical signals to send an analog speech signal converting part of the A/D and D/A converter (codec) 47. At this time, the two input speech signals are independently sent to carry out correlation operation, such that the noises in the speech signals are. The speech decoder 57 sends a control signal(a data input preparation signal) to the A/D and D/A converter (codec) 47, if a specific situation is not developed. In the meanwhile, the A/D and D/A converter (codec) 47 uses the frequency of 2.048 MHz as a value of x256FS for interpolation, and in this case, a synchronous frequency is 8 kHz, which is applied to a sampling rate for improving the speech recognition in the speech recognizer 53. Specifically, the 8 kHz sampling rate is regarded as an important processing basis for the recognition algorithm in the speech recognizer 53. Next, the input speech signals are A/D converted in the A/D and D/A converter (codec) 47, in which the data is independently inputted through the first and second microphones 39 and 41 and the noises therein are filtered by the correlation operation.

The noise-filtered digital speech sampling signal is temporarily stored in the frame unit in the circular buffer 51 and the inherent value for the user's speech by one word is calculated as feature vector data in the preemphasis 81 and the speech recognizing calculator 71. To detect the endpoint of each word, the zerocrossing rate 73, the data passes the power energy 75 and the unit speech detector 77 at the same time, and the detected endpoints are divided into the speech recognizing word in the preprocessor 79. Then, if the list controller 61 extracts the compression data of the first memory 33 corresponding to the speech recognizing word of the preprocessor 79, the extracted data and the Viterbi algorithm are moved to the second memory 35, where the operation for the speech recognition is performed.

In more detail, the speech recognition is completed in the order of the speech signal sampled at 8 kbps, the preprocessing (speech feature detection), the speech detection and the speech recognition. After the preprocessing step passes the calculating steps of power, hamming window, preemphasis and the like, it calculates a Mel scale of cepstrum relative to a real FFT-ed spectrum result. Alternatively, the zerocrossing rate and the power energy in the speech are calculated to thereby detect the starting point and endpoint of the speech.

In accordance with the two speech detection results, it is determined whether the speech recognition starts, ends or is reset, and the speech recognition is finally made by using the Mel scale of cepstrum coefficient row and the Viterbi algorithm for the HMM. The constants necessary for the numerous calculations are stored in the first memory 33 and are used whenever desired. The second memory 35 is used for the operation where a necessary value is computed, recorded and extracted. Because of the large scale of the data calculation, however, the list controller 61 is used. In this case, the detection of the endpoint of the speech for the speech recognition and compression is achieved by means of the unit speech detector 77 that is used for the increment of the recognition and compression rates.

On the other hand, the zerocrossing rate 73 and the power energy 75 exhibit a high detection effectiveness at a laboratory or in a relative silent room, but since they still suffer from a fundamental problem in detecting the endpoint of the speech which is sensitive to a substantially slight noise, they should be operated together with the Mel scale of cepstrum.

In other words, the power energy, the zerocrossing rate, and Mel scale cepstrum for the sampling signal which is made by mixing speech, noise, and mute are obtained and inputted to the unit speech detector 77, so that the speech (to which the noise is mixed) is outputted. The processed result is sent to the preprocessor 79 and is then recognized as the speech signal.

If the user's speech is recognized in the speech recognizer 53, the dialogue manager 55 selects any one of scenarios where the recognized speech is divided into a plurality of patterns. Next, the compression data of the response speech corresponding to the selected scenario is extracted from the list controller 61 and the first memory 33 and is then sent to the speech decoder 57.

The speech decoder 57 extends the compression data of the first memory 33 through a predetermined decoding process and restores the compression data as a digital speech signal, thereby audibly delivering the speech signal to the dialogue partner through the speech input/output part 37. At this time, the A/D and D/A converter 47, which is arranged between the speech decoder 57 and the speech input/output part 37, converts the digital speech signal into the analog speech signal to thereby generate a real speech.

In this case, if the dialogue partner's volume adjustment command ‘speak louder’ is inputted through the speech input/output part 37, it is inputted via the A/D and D/A converter 47 to the speech decoder 57. The volume controller 49, which has a predetermined gain in accordance with a volume control signal of the speech decoder 57, controls the power amplifier 45 to amplify the analog speech signal which is outputted to the A/D and D/A converter 47, so that the analog speech signal has a greater amplification gain value than a conventional one, thereby audibly sending the speech signal to the dialogue partner.

As clearly apparent from the foregoing, a toy having a speech recognition function and two-way conversation for a dialogue partner according to the present invention can associate a system comprised of a speech recognizer and a speech decoder with a dialogue manager where a predetermined scenario is developed, thus to have the speech recognition function and two-way conversation, whereby it can increase the desire of play as well as improve speech education efficiency.

It will be apparent to those skilled in the art that various modifications and variations can be made in a toy having a speech recognition function and two-way conversation for a dialogue partner of the present invention without departing from the spirit or scope of the invention. Thus, it is intended that the present invention cover the modifications and variations of this invention provided they come within the scope of the appended claims and their equivalents.

What is claimed is:

1. (Amended) A toy having a speech recognition function and two-way conversation for a dialogue partner, which has a first memory for storing speech compression data made by compressing a plurality of digital speech signal streams in a toy body that has a predetermined receiving space and is of at least one of human body and animal shapes and a second memory in which an operation space is arranged for recognizing a dialogue partner's speech signal inputted from the outside, said toy comprising:
a speech input/output part for converting at least one sentence of the dialogue partner's speech signal stored in said second memory into an electrical speech signal to output the converted signal and for audibly transmitting the speech signal restored to the dialogue partner;
a circular buffer in which the dialogue partner's digital speech signal outputted from said speech input/output part is temporarily stored;
a speech recognizer for dividing the digital speech signal stored in said circular buffer into speech recognizing words in accordance with speech recognizing constant of the compression data stored in said first memory to thereby recognize the dialogue partner's speech by Viterbi algorithm;
a dialogue manager for selecting at least one response sentence from said first memory to match the content of the speech recognized in said speech recognizer with a predetermined scenario;
a speech decoder for extending and restoring the speech compression data of said first memory selected from said dialogue manager;
an analog/digital and digital/analog converter arranged between said speech decoder and said speech input/output part, for converting one side of analog and digital speech signals into the other side thereof; and
a memory controller arranged between said second memory and said speech recognizer, for moving the data from said first memory to said second memory.

2. (Deleted)

3. (Deleted)

4. (Deleted)

5. (Amended) The toy of claim 1, wherein between said speech recognizer and said first memory and said dialogue manager and said first memory, there is provided a list controller for extracting the speech compression data and the speech recognizing constant from said first memory and for moving the speech recognizing data to said second memory.

6. The toy of claim 1, wherein said speech recognizer is comprised of:
a speech recognizing calculator for eliminating a predetermined noise from the digital speech signal in a frame unit stored in said circular buffer in accordance with the speech recognizing constant of said first memory to thereby calculate an inherent value for a single character as feature vector data;
a zerocrossing rate for detecting a zero point in a sampling value of the digital speech signal;
a power energy for calculating energy for the zero point to improve the reliability for the zero point detection at said zerocrossing rate;
a unit speech detector for detecting endpoint data of any one word of the continuous digital speech signals, based upon the output signal of said zerocrossing rate and said power energy;
a preprocessor for dividing the feature vector data of said speech recognizing calculator and the endpoint data of said unit speech detector by one word into the speech recognizing word; and
said second memory for providing an operation area where the speech compression data of said first memory corresponding to the divided word in said preprocessor which has been extracted by means of said list controller is operated by the Viterbi algorithm.

7. (Amended) The toy of claim 1, further comprising: a plurality of touch switches mounted on plural areas, for example, the back, nose, mouth, and hip, of said toy body and serving to inform said speech decoder of the dialogue partner's contact with said toy body.

8. (Amended) The toy of claim 7, wherein if the dialogue partner contacts said plurality of touch switches, the speech corresponding to the touched situation is extracted from said dialogue manager and said first memory and then extended and restored into a real speech in said speech decoder, such that the real speech is audibly sent to the dialogue partner via said speech input/output part.

9. (Amended) The toy of claim 1, wherein said speech input/output part is comprised of:
a first microphone for converting the dialogue partner's speech and the noise generated from the outside into an electrical signal to thereby output the converted signal to said circular buffer;
a second microphone for converting the noise generated from the outside into an electrical signal to thereby output the converted signal to said circular buffer; and
a power amplifier for amplifying the extended and restored speech signal from said speech decoder to audibly deliver the amplified signal via a speaker to the dialogue partner.

10. (Amended) The toy of claim 9, wherein said analog/digital and digital/analog converter is arranged between said circular buffer and said first and second microphones, for converting the output signals from said first and second microphones into digital signals, and also arranged between said speech decoder and said power amplifier, for converting the extended and restored digital speech signal from said speech decoder into an analog signal.

11. (Amended) The toy of claim 10, wherein between said A/D and D/A converters and said power amplifier, there is provided a volume controller for adjusting an output strength of said power amplifier in response to the dialogue partner's volume adjustment command (for example, “speak louder” and “speak softer”).

12. (Deleted)

13. (Added) The toy of claim 1, wherein said circular buffer, said speech recognizer, said dialogue manager, said speech decoder, said list controller, a timer and a clock generator are all contained within a single chip.
